(19) United States
(12) Patent Application Publication
(10) Pub. No.: US 2014/0010637 A1
(43) Pub. Date: Jan. 9, 2014

(54) TORQUE BOX AND LINKAGE DESIGN

(71) Applicants: Bernard W. Pudvah, Portland, CT (US); Eugene C. Gasmen, Rocky Hill, CT (US); Stanley Wiecko, Newington, CT (US)

(72) Inventors: Bernard W. Pudvah, Portland, CT (US); Eugene C. Gasmen, Rocky Hill, CT (US); Stanley Wiecko, Newington, CT (US)

(73) Assignee: UNITED TECHNOLOGIES CORPORATION, Hartford, CT (US)

(21) Appl. No.: 13/541,930

(22) Filed: Jul. 5, 2012

(51) Int. Cl. F03B 3/12

(52) U.S. Cl. 415/130

(57) ABSTRACT

An assembly includes a torque box and a first bell crank. The torque box has a housing with an interior cavity. The first bell crank is pivotally supported from the housing and extends through the interior cavity. The first bell crank has three arms for transferring an actuating force to a plurality of variable guide vanes for positioning the guide vanes within a gas turbine engine.

### BACKGROUND

The present invention is related to gas turbine engines, and in particular to a torque box and linkages for positioning variable guide vanes.

Gas turbine engines rely on rotating and stationary components to effectively and efficiently control the flow of air through the engine. Rotating components include rotor blades employed in compressor and turbine sections for compressing air and extracting energy from air after combustion. Stationary components include vanes placed in the airflow to aid in directing airflow. By varying the position of the vanes (i.e., rotating them to vary the profile provided to the airflow), airflow characteristics can be optimized for various operating conditions.

The mechanism for providing precise, controlled, and uniform actuation of the vanes is a linear actuator connected to the plurality of variable guide vanes via a series of linkages. The actuator is typically mounted to the exterior of the engine case, and communicates power to the series of linkages via a bell crank or similar mechanical device. Installation and alignment of the actuator relative to the bell crank and other linkages is critical to achieving a desired positioning of the variable guide vanes. However, factors such as thermal growth during various flight conditions and system mechanical errors can adversely affect the alignment of the actuator with the linkages including the bell crank. This misalignment results in errors between the desired position of variable guide vanes and the actual position of the variable guide vanes.

### SUMMARY

An assembly includes a torque box and a first bell crank. The torque box has a housing with an interior cavity. The first bell crank is pivotally supported from the housing and extends through the interior cavity. The first bell crank has three arms for transferring an actuating force to a plurality of variable guide vanes for positioning the guide vanes within a gas turbine engine.

A gas turbine engine includes an engine case, a compressor and/or turbine section with a first stage and a second stage of variable guide vanes, a torque box, a plurality of linkages, and a linear actuator. The first stage of variable guide vanes is circumferentially spaced radially inward of the engine case, and the second stage of variable guide vanes is circumferentially spaced radially inward of the engine case. The first stage is axially spaced from the second stage. The torque box is mounted to the engine case and the linear actuator is mounted to the torque box. The plurality of linkages extend through and pivot about the torque box. The linear actuator is coupled to the plurality of linkages and selectively positions the first stage and the second stage via the linkages.

### BRIEF DESCRIPTION OF THE DRAWINGS

FIG. 1 is a cross-sectional view of a gas turbine engine according to an embodiment of the present invention.

FIG. 2 is a top-view of one embodiment of an actuator and torque box positioned above an engine case according to an embodiment of the present invention.

FIG. 2A is a perspective view of the torque box of FIG. 2 and a first embodiment of a linkage assembly.

FIG. 2B is a perspective view of the linkage assembly of FIG. 2A with the torque box housing removed.

FIG. 3A is a perspective view of the torque box and a second embodiment of the linkage assembly.

FIG. 3B is a perspective view of the linkage assembly of FIG. 3A with the torque box housing removed.

FIG. 3C is a sectional view of a connection between components of the linkage assembly of FIGS. 3A and 3B.

### DETAILED DESCRIPTION

The present application discloses an assembly that includes an actuator mounted to a torque box. The assembly communicates power and force to vanes via a series of linkages including a bell crank, which extends through a hollow interior cavity of the torque box. The assembly of the actuator, torque box, and linkages allows for precise alignment and positioning of vanes. The configuration of the assembly minimizes factors such as engine case thermal growth and system mechanical error that adversely affect the alignment of the actuator with the linkages, and thereby, reduces errors between the desired position of engine variable guide vanes and the actual position of the variable guide vanes.

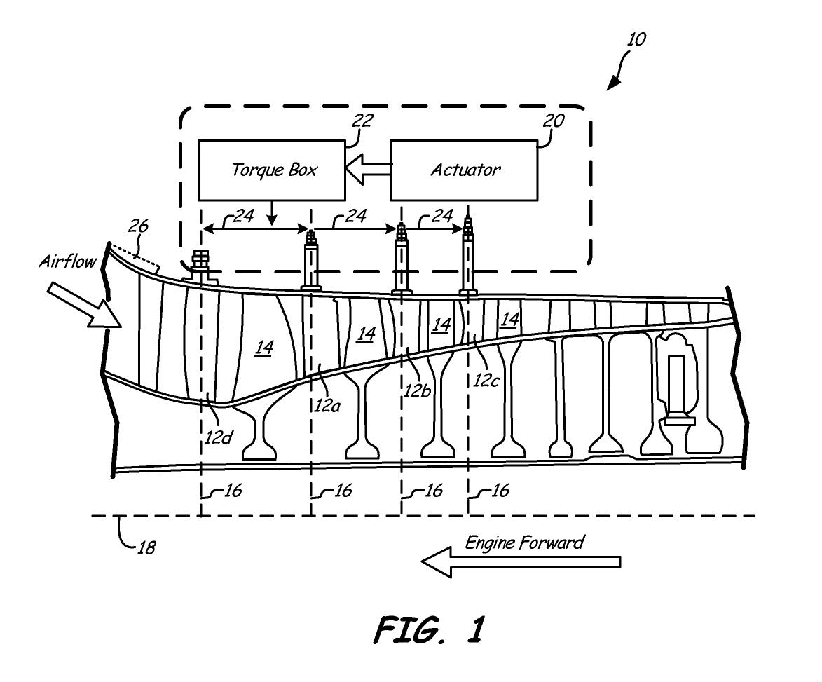

FIG. 1 is a cross-sectional view of a compressor section of a gas turbine engine including an assembly 10 according to an embodiment of the present invention. Although FIG. 1 references the compressor section principles of the present invention may be applied to a turbine section of a gas turbine engine as well. In the cross-sectional view shown in FIG. 1, assembly 10 includes a plurality of rotatable variable guide vanes (VGV) 12a-12d, a plurality of rotor blades 14, an actuator 20, a torque box 22 and a plurality of assembly of linkages 24.

In the embodiment shown in FIG. 1, VGVs 12a-12d comprise stages 1-3 VGVs 12a-12c and inlet guide vane (IGV) 12d. With respect to VGVs 12a-12c, each is rotatable about an axis 16 that is substantially perpendicular with engine centerline axis 18. With respect to IGV 12d, IGV 12d is rotatable about an axis 16 that is 3° angled aft of the engine centerline axis 18. The performance of gas turbine engine is modified, in part, by adjusting the position of stationary VGVs 12a-12d to selectively vary airflow characteristics of the engine.

The mechanical force used to change the position of VGVs 12a-12d is provided by actuator 20, and is communicated via assembly of linkages 24 to VGVs 12a-12d. Actuator 20 and torque box 22 are positioned radially outward of engine case 26. Torque box 22 is mechanically attached to engine case 26, while actuator 20 is mechanically coupled to torque box 22.

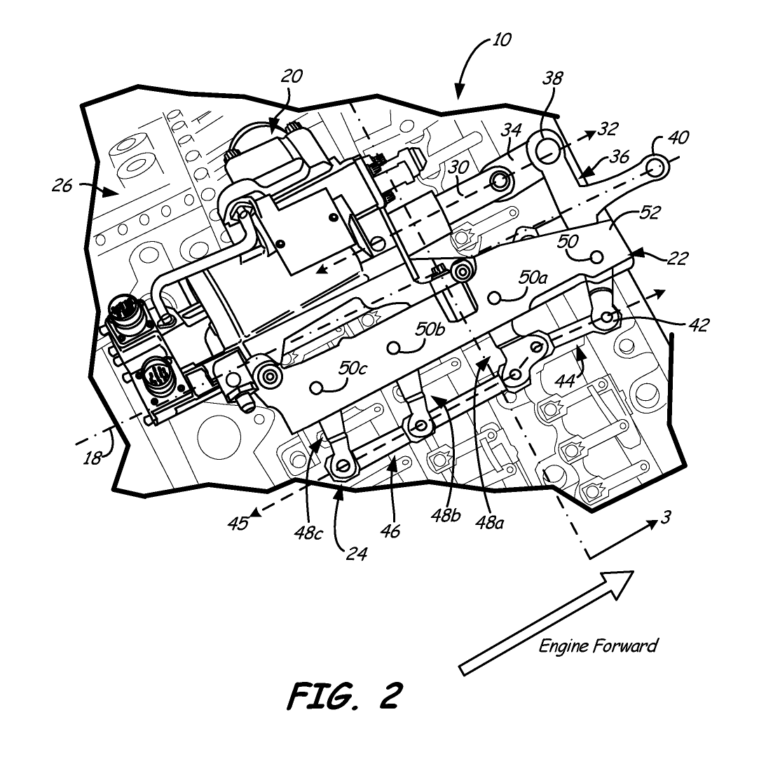

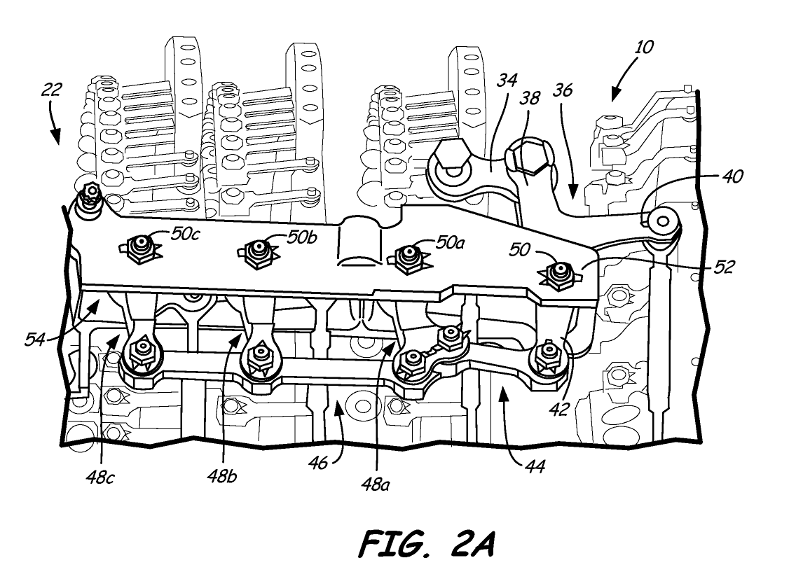

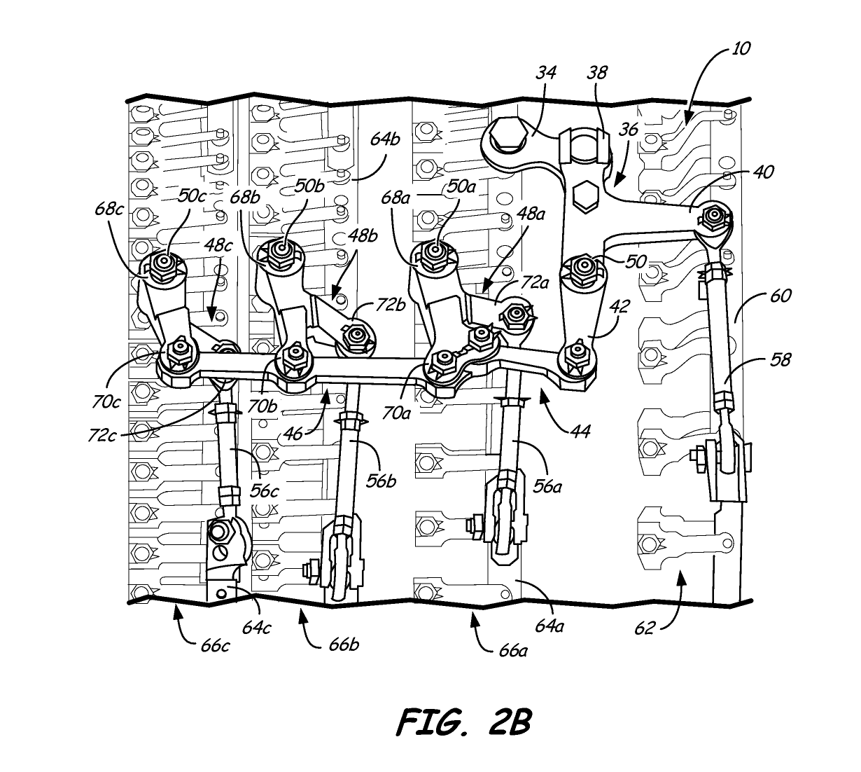

FIG. 2 is a top-view of assembly 10 including actuator 20 and torque box 22 positioned above engine case 26 according to an embodiment of the present invention. In addition to actuator 20, torque box 22, and assembly of linkages 24, assembly 10 includes an actuator arm 30, a dog-bone arm 34, a first bell crank 36, a four-bar linkage 44, a sync rod 46, a second bell crank 48a, a third bell crank 48b, and a fourth bell crank 48c.

Actuator 20 is a linear actuator that provides mechanical force in the direction indicated by line 32. Actuator 20 is mechanically fixed to a first side of torque box 22. Actuator arm 30 is connected to dog-bone arm 34, which in turn is connected to first bell crank 36. In the embodiment shown in FIG. 2, first bell crank 36 includes three arms including a first arm 38, a second arm 40, and a third arm 42. First arm 38 is mechanically coupled to dog-bone arm 34. Second arm 40 is connected to an inlet guide vane linkage to turn a unison ring (not shown) and pivot inlet guide vanes 12d (FIG. 1). Third arm 42 is mechanically coupled to four-bar linkage 44. First bell crank 36 is supported by and pivotally connected to torque box 22 at pivot point 50.

Four-bar linkage 44 is connected to first bell crank 36 and extends to connect to second bell crank 48a. Additionally, second bell crank 48a is connected to sync rod 46 which is disposed adjacent four-bar linkage 44. Second bell crank 48a is supported by and pivotally connected to torque box 22 at pivot point 50a.

Together four-bar linkage 44 and sync rod 46 extend along a second opposing side of torque box 22 from actuator 20. In addition to connecting to second bell crank 48a, sync rod 46 connects to third bell crank 48b and fourth bell crank 48c. Similar to first and second bell cranks 36 and 48a, third and fourth bell cranks 48b and 48c are supported by and are pivotally connected to torque box 22 at pivot points 50b and 50c.

Mechanical force applied by actuator 20 in the direction indicated by line 32 results in first bell crank 36 pivoting about point 50. The action of first bell crank 36 applies mechanical force via third arm 42 to four-bar linkage 44 in a direction indicated by arrow 45, a direction opposite to the direction of first arm 38. Conversely, mechanical force applied by actuator 20 in a direction opposite of line 32 results in mechanical force being applied by third arm 42 to assembly of linkages 24 including four-bar linkage 44 and sync rod 46 in a direction opposite that indicated by arrow 45.

A plurality of unison rings (not shown) are positioned circumferentially around engine case 26, including at least one unison ring located forward of first bell crank 36. Unison ring is attached to actuator 20 via second arm 40 of bell crank 36 as well as a linkage (not shown). Each unison ring is associated with the VGVs 12a-12d, respectively, shown in FIG. 1. Mechanical motion provided via assembly of linkages 24 (specifically, four-bar linkage 44 and sync rod 46) in a direction indicated by arrow 45 is communicated to the unison rings by second, third, and fourth bell cranks 48a-48c and linkages (not shown). Communicated force results in the unison rings moving in a circumferential direction that results in angular positioning of VGVs 12a-12d relative to gas flow through gas turbine engine.

FIGS. 2A and 2B further illustrate the embodiment of assembly 10 with actuator 20 removed. FIG. 2A illustrates torque box 22, which includes an open housing 52 with an internal cavity 54. FIG. 2B further illustrates linkages with torque box 22 removed. Thus, assembly 10 includes actuator arm 30 (FIG. 2), dog-bone arm 34, first bell crank 36, first arm 38, second arm 40, third arm 42, four-bar linkage 44, sync rod 46, second bell crank 48a, third bell crank 48b, fourth bell crank 48c, and pivot points 50, 50a, 50b, and 50c. FIG. 2B additionally illustrates links 56a-56c, inlet guide vane (IGV) link 58, IGV unison ring 60, IGV vane arms 62, VGV unison rings 64a-64c, and VGV vane arms 66a-66c. FIG. 2B also illustrates second bell crank 48a, which includes a first arm 68a, a second arm 70a, and a third arm 72a. Third bell crank 48b includes a first arm 68b, a second arm 70b, and a third arm 72b. Fourth bell crank 48c includes a first arm 68c, a second arm 70c, and a third arm 72c.

As shown in FIG. 2A, first bell crank 36 extends through open housing 52 via internal cavity 54 of torque box 22 to connect with four-bar linkage 44. First bell crank 36 along with second bell crank 48a, third bell crank 48b, and fourth bell crank 48c are mounted within internal cavity 54 and pivot about pivot points 50, 50a, 50b, and 50c.

Second arm 40 of first bell crank 36 connects to IGV link 58 forward of torque box 22. As shown in FIG. 2B, IGV link 58 extends to connect to IGV unison ring 60. IGV unison ring 60 extends around at least a portion of engine case 26 (FIG. 2) and is movable in a circumferential direction relative thereto. IGV unison ring 60 is connected to IGV vane arms 62, which move with IGV unison ring 60 to change the angular position of IGVs 12d (FIG. 1) relative to flow through gas turbine engine. In one embodiment, the angular position of IGV 12d differs from the angular position of other VGVs 12a-12c.

Four-bar linkage 44 is connected to first bell crank 36 and extends to connect to second bell crank 48a. Additionally, second bell crank 48a is connected to sync rod 46 which is disposed adjacent four-bar linkage 44. Second bell crank 48a is supported by and pivotally connected to torque box 22 at pivot point 50a.

As shown in FIG. 2B, four-bar linkage 44 connects from third arm 42 of first bell crank 36 to second arm 70a of second bell crank 48a. Additionally, second arm 70a of second bell crank 48a is connected to sync rod 46. First arm 68a of second bell crank 48a extends to pivot point 50a. Third arm 72a connects to link 56a, which extends to connect to VGV unison ring 64a. VGV unison ring 64a extends around at least a portion of engine case 26 (FIG. 2) and is movable in a circumferential direction relative thereto. VGV unison ring 64a is connected to VGV vane arms 66a. VGV vane arms 66a move with VGV unison ring 64a to change the angular position of VGVs 12a (FIG. 1) relative to gas flow through gas turbine engine.

Sync rod 46 extends from second bell crank 48a to connect to third bell crank 48b and fourth bell crank 48c. Similar to second bell crank 48a, third bell crank 48b and fourth bell crank 48c are supported by and pivotally connected to torque box 22 at pivot points 50b and 50c, respectively.

As shown in FIG. 2B, sync rod 46 connects to second arms 70b and 70c of third and fourth bell crank 48b and 48c, respectively. First arms 68b and 68c of third bell crank 48b and fourth bell crank 48c extend to pivot points 50b and 50c, respectively. Third arms 72b and 72c of third bell crank 48b and fourth bell crank 48c connect to links 56b and 56c, respectively. Link 56b extends to connect to VGV unison ring 64b. Link 56c extends to connect to VGV unison ring 64c. VGV unison rings 64b and 64c extend around at least a portion of engine case 26 (FIG. 2) and are circumferentially movable relative thereto. VGV unison rings 64b and 64c are connected to VGV vane arms 66b and 66c. VGV vane arms 66b and 66c move with VGV unison rings 64b and 64c to change the angular position of VGVs 12b and 12c (FIG. 1) relative to gas flow through gas turbine engine.

The mechanical force applied by actuator 20 (FIG. 2) results in first bell crank 36 pivoting about pivot point 50. The action of first bell crank 36 applies mechanical force via third arm 42 to four-bar linkage 44 and to IGV link 58 (FIG. 2B) via second arm 40. Mechanical force from four-bar linkage 44 pivots second bell crank 48a and force is transferred to VGV link 56a via third arm 72a. Similarly, mechanical force is transferred from four-bar linkage 44 to second bell crank 48a and from second bell crank 48a to sync rod 46 and on to third bell crank 48b and fourth bell crank 48c. Force pivots third bell crank 48b and fourth bell crank 48c and is transferred to VGV links 56b and 56c. In response to force applied via VGV links 56a-56c, unison rings 64a-64c translate generally circumferentially relative to engine case 26 (FIGS. 1 and 2) to move VGV vane arms 66a-66c (FIG. 2B) and align VGVs 12a-12c (FIG. 1) relative to gas flow through gas turbine engine.

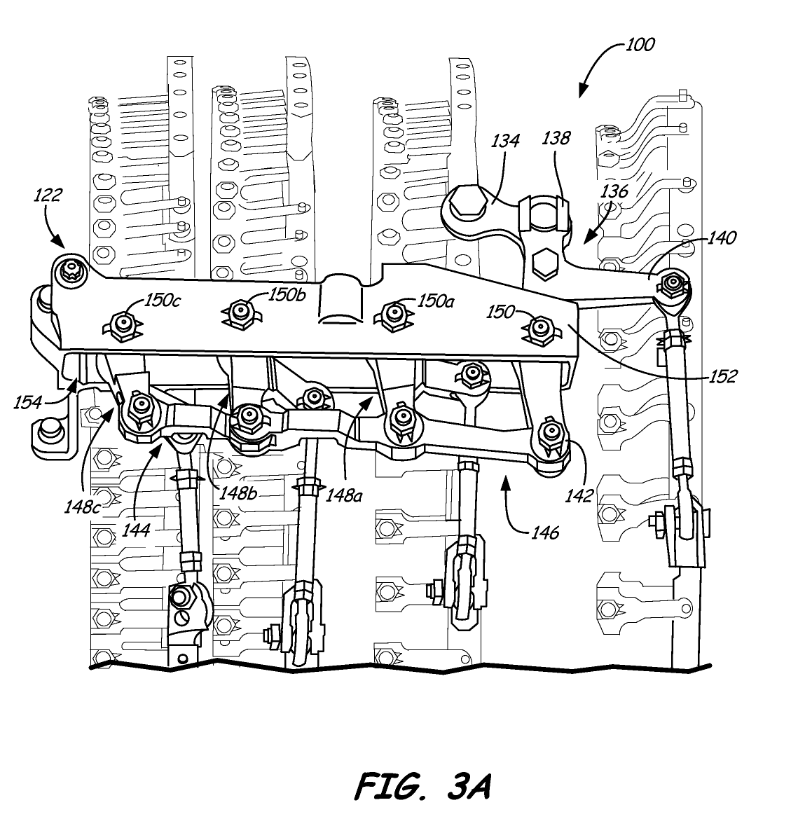

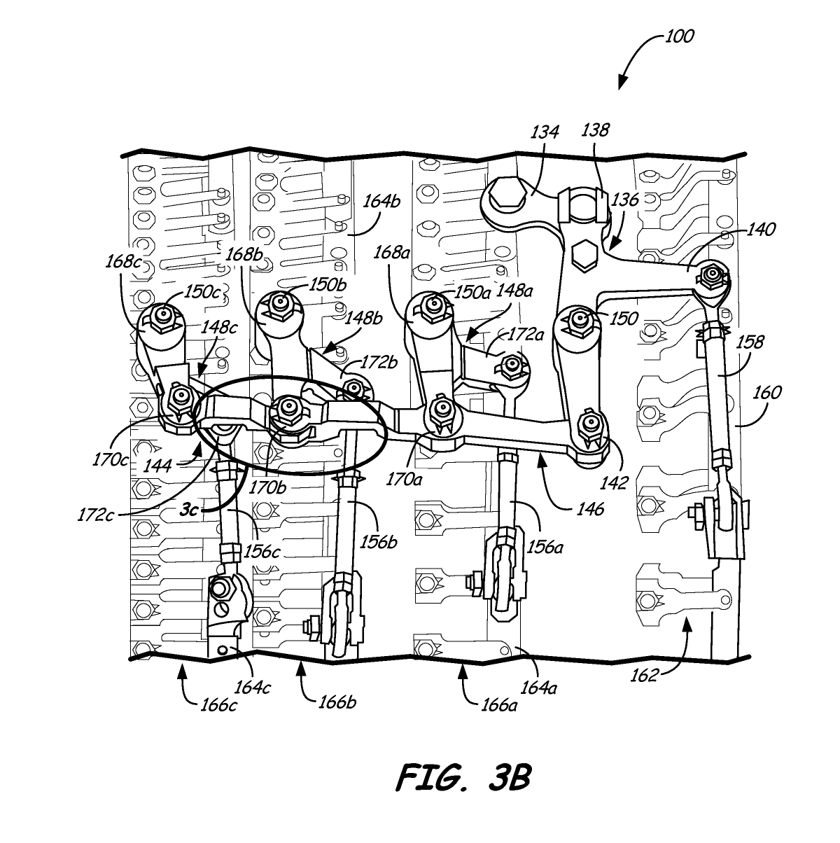

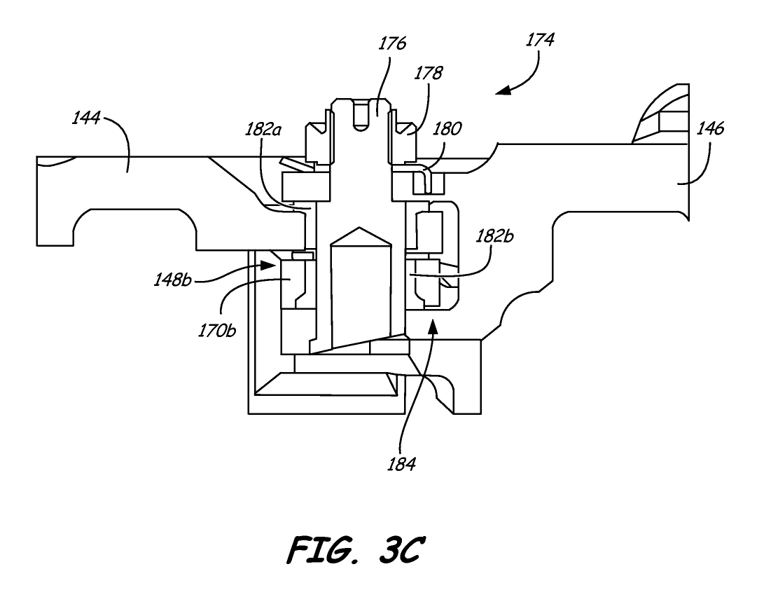

FIGS. 3A and 3B illustrate a second embodiment of assembly 100 with actuator removed. FIG. 3A illustrates torque box 122 which includes an open housing 152 with an internal cavity 154. FIG. 3B further illustrates linkages with torque box 122 removed. Assembly 100 includes a dog-bone arm 134, a first bell crank 136, a first arm 138, a second arm 140, a third arm 142, a four-bar linkage 144, a sync rod 146, a second bell crank 148a, a third bell crank 148b, a fourth bell crank 148c, and pivot points 150, 150a, 150b, and 150c. As shown in FIG. 3B, assembly 100 includes links 156a-156c, an inlet guide vane (IGV) link 158, a IGV unison ring 160, IGV vane arms 162, VGV unison rings 164a-164c, and VGV vane arms 166a-166c. FIG. 3B also illustrates second bell crank 148a, which includes a first arm 168a, a second arm 170a, and a third arm 172a. Third bell crank 148b includes a first arm 168b, a second arm 170b, and a third arm 172b. Fourth bell crank 148c includes a first arm 168b, a second arm 170c, and a third arm 172c.

As shown in FIG. 3A, first bell crank 136 extends through open housing 152 via internal cavity 154 of torque box 122 to connect with sync rod 146. First bell crank 136 along with second bell crank 148a, third bell crank 148b, and fourth bell crank 148c are mounted within internal cavity 154 and pivot about pivot points 150, 150a, 150b, and 150c, respectively.

Second arm 140 of first bell crank 136 connects to IGV link 158 (FIG. 3B) forward of torque box 122 (FIG. 3A). As shown in FIG. 3B, IGV link 158 extends to connect to IGV unison ring 160. IGV unison ring 160 extends around at least a portion of engine case 26 (not shown) and is movable in a circumferential direction relative thereto. IGV unison ring 160 is connected to IGV vane arms 162. IGV vane arms 162 move with IGV unison ring 160 to change the angular position of IGVs 12d (FIG. 1) relative to gas flow through gas turbine engine. In one embodiment, the angular position of IGV 12d differs from the angular position of the other VGVs 12a-12c.

As shown in FIG. 3A, sync rod 146 is connected to first bell crank 136 and extends to connect to second bell crank 148a and third bell crank 148b. Additionally, third bell crank 148b is connected to both four-bar linkage 144 and sync rod 146 via a clevis in sync rod 146. Second bell crank 148a and third bell crank 148b are supported by and pivotally connected to torque box 122 at pivot points 150a and 150b, respectively.

As shown in FIG. 3B, sync rod 146 connects from third arm 142 of first bell crank 136 to second arm 170a of second bell crank 148a and second arm 170b of third bell crank 148c. First arm 168a of second bell crank 148a and first arm 168b of third bell crank 148b extend to pivot points 150a and 150b, respectively. Third arm 172a of second bell crank 148a connects to link 156a, which extends to connect to VGV unison ring 164a. Similarly, third arm 172b of third bell crank 148b connects to link 156b, which extends to connect to VGV unison ring 164b. VGV unison rings 164a and 164b extend around at least a portion of engine case (not shown) and are circumferentially movable relative thereto. VGV unison rings 164a and 164b are connected to VGV vane arms 166a and 166b, respectively. VGV vane arms 166a and 166b move with VGV unison rings 164a and 164b to change the angular position of VGVs 12a and 12b (FIG. 1) relative to gas flow through gas turbine engine.

Four-bar linkage 144 extends from sync rod 146 and third bell crank 148b to connect to fourth bell crank 148c. Similar to second bell crank 148a and third bell crank 148b, fourth bell crank 148c is supported by and pivotally connected to torque box 122 at pivot point 150c.

As shown in FIG. 3B, first arm 168c of fourth bell crank 148c extends to pivot point 150c. Third arm 172c of fourth bell crank 148c connects to link 156c. Link 156c extends to connect to VGV unison ring 164c. VGV unison ring 164c extends around at least a portion of engine case (not shown) and is circumferentially movable relative thereto. VGV unison ring 164c is connected to VGV vane arms 166c. VGV vane arms 166c move with VGV unison ring 164c to change the angular position of VGVs 12c (FIG. 1) relative to gas flow through gas turbine engine.

Mechanical force applied by actuator (not shown) results in first bell crank 136 pivoting about pivot point 150. The action of first bell crank 136 applies mechanical force via third arm 142 to sync rod 146 and to IGV link 158 via second arm 140. Mechanical force from sync rod 146 pivots second bell crank 148a and third bell crank 148b, and force is transferred to VGV links 156a and 156b via third arms 172a and 172b. Similarly, mechanical force is transferred from sync rod 146 to four-bar linkage 144 and from four bar linkage 144 to fourth bell crank 148c. Force pivots fourth bell crank 148c and is transferred to VGV link 156c. In response to force applied via VGV links 156a-156c, unison rings 164a-164c translate generally circumferentially relative to engine case 26 (not shown) to move VGV vane arms 166a-166c and align VGVs 12a-12c (FIG. 1) relative to gas flow through gas turbine engine.

FIG. 3C is a sectional view of a connection assembly 174 between third bell crank 148b, sync rod 146, and four-bar linkage 144. In FIG. 3C, connection assembly 174 includes a pin 176, a nut 178, a tab washer 180, bushings 182a and 182b, and a clevis 184.

Pin 176 is tapered with varying diameters and extends through sync rod 146, four-bar linkage 144, and second arm 170b of third bell crank 148b. Nut 178 fastens to pin 176 at its smallest diameter and holds tab washer 180 against an upper surface of sync rod 146. Bushing 182a is disposed between pin 176 and four bar linkage 144, and bushing 182b is disposed between pin 176 and second arm 170b of third bell crank 148b. End portions of four-bar linkage 144, third bell crank 148b, as well as pin 176 and bushings 182a and 182, extend into clevis and are received in clevis 184 of sync rod 146.

Together pin 176 and nut 178 act to couple sync rod 146, four-bar linkage 144, and third bell crank 148b together. Clevis 184 allows for coupling of sync rod 146, four-bar linkage 144, and third bell crank 148b with a single pin 176 connection. Thus, additional pin connections are eliminated from assembly 100 (FIGS. 3A and 3B) reducing the weight and the potential for error in assembly 100.

The present application discloses an assembly that includes an actuator mounted to a torque box. The assembly communicates power and force to vanes via a series of linkages including a bell crank, which extends through a hollow interior cavity of the torque box. The assembly of the actuator, torque box, and linkages allows for precise alignment and positioning of vanes. The configuration of the assembly minimizes factors such as engine case thermal growth and system mechanical error that adversely affect the alignment of the actuator with the linkages, and thereby, reduces errors between the desired position of engine variable guide vanes and the actual position of the variable guide vanes.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

In a further embodiment of any of the foregoing embodiments, the assembly and/or gas turbine engine may additionally or alternatively include an actuator mounted to a first side of the torque box, the actuator connects to the first bell crank and provides the actuating force to the variable guide vanes via the first bell crank

In a further embodiment of any of the foregoing embodiments, the assembly and/or gas turbine engine may additionally or alternatively include a plurality of linkages disposed on a second side of the torque box.

In a further embodiment of any of the foregoing embodiments, the assembly and/or gas turbine engine may additionally or alternatively include a four-bar linkage connected to the first bell crank and extending to connect to a second bell crank and a sync rod connected to at least one of the four-bar linkage or the second bell crank.

In a further embodiment of any of the foregoing embodiments, the assembly and/or gas turbine engine may additionally or alternatively include at least three bell cranks including the second bell crank are connected to the sync rod, and each bell crank is pivotally disposed within the interior cavity of the torque box.

In a further embodiment of any of the foregoing embodiments, the assembly and/or gas turbine engine may additionally or alternatively include at least one of the four-bar linkage or the sync rod includes a clevis allowing for a direct connection of the sync rod to the four-bar linkage and the first bell crank.

In a further embodiment of any of the foregoing embodiments, the assembly and/or gas turbine engine may additionally or alternatively include a sync rod connected to the first bell crank and extending to connect to a plurality of bell cranks and a four-bar connected to at least one of the four-bar linkage or one of the plurality of bell cranks.

In a further embodiment of any of the foregoing embodiments, the assembly and/or gas turbine engine may additionally or alternatively include the plurality of bell cranks comprises at least three bell cranks including the first bell crank, and each bell crank is pivotally disposed within the interior cavity of the torque box.

In a further embodiment of any of the foregoing embodiments, the assembly and/or gas turbine engine may additionally or alternatively include at least one of the four-bar linkage or the sync rod includes a clevis allowing for a direct connection of the sync rod to the four-bar linkage and one of the plurality of bell cranks.

In a further embodiment of any of the foregoing embodiments, the assembly and/or gas turbine engine may additionally or alternatively include the first bell crank transfers force to a stage of inlet guide vanes.

In a further embodiment of any of the foregoing embodiments, the assembly and/or gas turbine engine may additionally or alternatively include each stage of variable guide vanes including the second stage rotates to an angle of rotation that differ from an angle of rotation of the first stage.

In a further embodiment of any of the foregoing embodiments, the assembly and/or gas turbine engine may additionally or alternatively include the actuator is mounted to a first side of the torque box, and the plurality of linkages are disposed on a second opposing side of the torque box to the actuator.

1. An assembly comprising:
a torque box having a housing with an interior cavity; and
a first bell crank pivotally supported from the housing and extending through the interior cavity, wherein the first bell crank has a plurality of arms for transferring an actuating force to a plurality of variable guide vanes for positioning the guide vanes within a gas turbine engine.

2. The assembly of claim 1, further comprising:
an actuator mounted to a first side of the torque box, wherein the actuator connects to the first bell crank and provides the actuating force to the variable guide vanes via the first bell crank.

3. The assembly of claim 2, further comprising:
a plurality of linkages disposed on a second side of the torque box, wherein the second side opposes the first side of the torque box.

4. The assembly of claim 3, wherein the plurality of linkages comprises:
a four-bar linkage connected to the first bell crank and extending to connect to a second bell crank; and
a sync rod connected to at least one of the four-bar linkage or the second bell crank.

5. The assembly of claim 4, wherein at least three bell cranks including the second bell crank are connected to the sync rod, and wherein each bell crank is pivotally disposed within the interior cavity of the torque box.

6. The assembly of claim 4, wherein at least one of the four-bar linkage or the sync rod includes a clevis allowing for a direct connection of the sync rod to the four-bar linkage and the first bell crank.

7. The assembly of claim 3, wherein the plurality of linkages comprises:
a sync rod connected to the first bell crank and extending to connect to a plurality of bell cranks; and
a four-bar linkage connected to at least one of the four-bar linkage or one of the plurality of bell cranks.

8. The assembly of claim 7, wherein the plurality of bell cranks comprises at least three bell cranks including the first bell crank, and wherein each bell crank is pivotally disposed within the interior cavity of the torque box.

9. The assembly of claim 7, wherein at least one of the four-bar linkage or the sync rod includes a clevis allowing for a direct connection of the sync rod to the four-bar linkage and one of the plurality of bell cranks.

10. The assembly of claim 1, wherein the first bell crank transfers force to a stage of inlet guide vanes.

11. A gas turbine engine comprising:
an engine case;
a compressor and/or turbine section having at least a first stage of variable guide vanes circumferentially spaced radially inward of the engine case, and a second stage of variable guide vanes circumferentially spaced radially inward of the engine case, wherein the first stage is axially spaced from the second stage;
a torque box mounted to the engine case;
a plurality of linkages, at least one linkage of the plurality of linkages extending through and pivoting about the torque box; and
a linear actuator mounted to the torque box and coupled to the plurality of linkages to selectively position the first stage of variable guide vanes and the second stage of variable guide vanes.

12. The gas turbine engine of claim 11, wherein each stage of variable guide vanes including the second stage rotates to an angle of rotation that differ from an angle of rotation of the first stage.

13. The gas turbine engine of claim 11, wherein the plurality of linkages comprises:
a four-bar linkage connected to the first bell crank and extending to connect to a second bell crank; and
a sync rod connected to at least one of the four-bar linkage or the second bell crank.

14. The gas turbine engine of claim 13, wherein at least three bell cranks including the second bell crank are connected to the sync rod, and wherein each bell crank is pivotally disposed within the interior cavity of the torque box.

15. The gas turbine engine of claim 13, wherein at least one of the four-bar linkage or the sync rod includes a clevis allowing for a direct connection of the sync rod to the four-bar linkage and the second bell crank.

16. The gas turbine engine of claim 11, wherein the plurality of linkages comprises:
a sync rod connected to the first bell crank and extending to connect to a plurality of bell cranks; and
a four-bar linkage connected to at least one of the four-bar linkage or one of the plurality of bell cranks.

17. The gas turbine engine of claim 16, wherein the plurality of bell cranks comprises at least three bell cranks including the first bell crank, and wherein each bell crank is pivotally disposed within the interior cavity of the torque box.

18. The gas turbine engine of claim 16, wherein at least one of the four-bar linkage or the sync rod includes a clevis allowing for a direct connection of the sync rod to the four-bar linkage and one of the plurality of bell cranks.

19. The gas turbine engine of claim 11, wherein the first stage comprises an inlet guide vane stage.

20. The gas turbine engine of claim 11, wherein the actuator mounted to a first side of the torque box, and wherein the plurality of linkages are disposed on a second opposing side of the torque box to the actuator.
